(19) United States
(12) Patent Application Publication
(10) Pub. No.: US 2008/0083091 A1
(43) Pub. Date: Apr. 10, 2008

(54) Twin mounted hinge pin hanger

(76) Inventor: Trevor John Palairet, Nambour (AU)

Correspondence Address: Dr. Trevor John Palairet, C/O Nambour General Hospital, Nambour , Queensland, 4560, AU

(21) Appl. No.: 11/824,744

(22) Filed: Jul. 3, 2007

(30) Foreign Application Priority Data
Oct. 31, 2005 (NZ) 543298

(51) Int. Cl. E05D 11/00; A47G 25/28

(52) U.S. Cl. 16/404

(57) ABSTRACT

A typical door hinge pin may be removed and replaced by a longer stainless steel (or suitable alternative) rod which is bent into a rail or hanger of any suitable size and shape which swings from the hinge and is suitable for hanging items such as towels and clothes. The unique feature of this invention is that both ends of the rod are inserted into a hinge channel, allowing more sturdiness and versatility than similar rails with a single mounting. The two ends can either be inserted into the same hinge in a pincer-like fashion from above and below and secured by attaching a strut, or be inserted into two separate hinges, both from above, thus providing scope for a larger rail structure. Other notable features of the hanger include its durability, ease of manufacture, its scope for decorative forms, scope for attaching accessories such as hooks and support struts, the ease of installation and dismantlement, and lack of any damage resulting from this method of mounting.

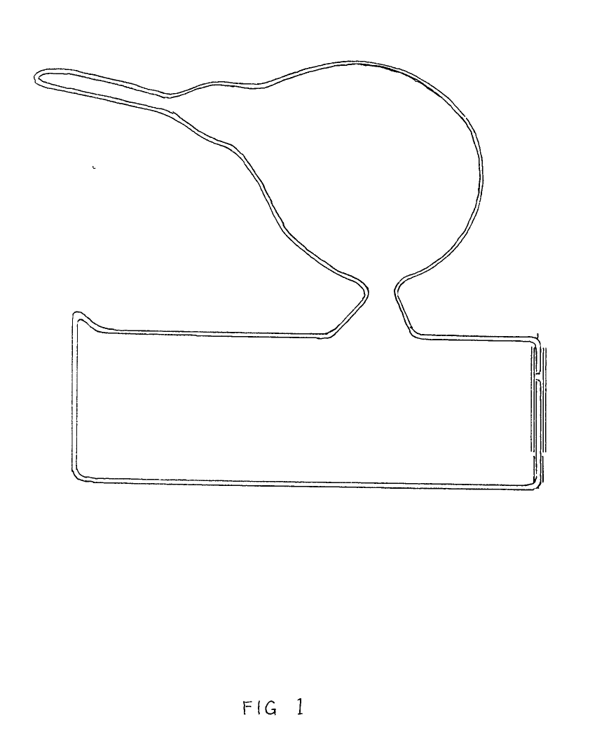

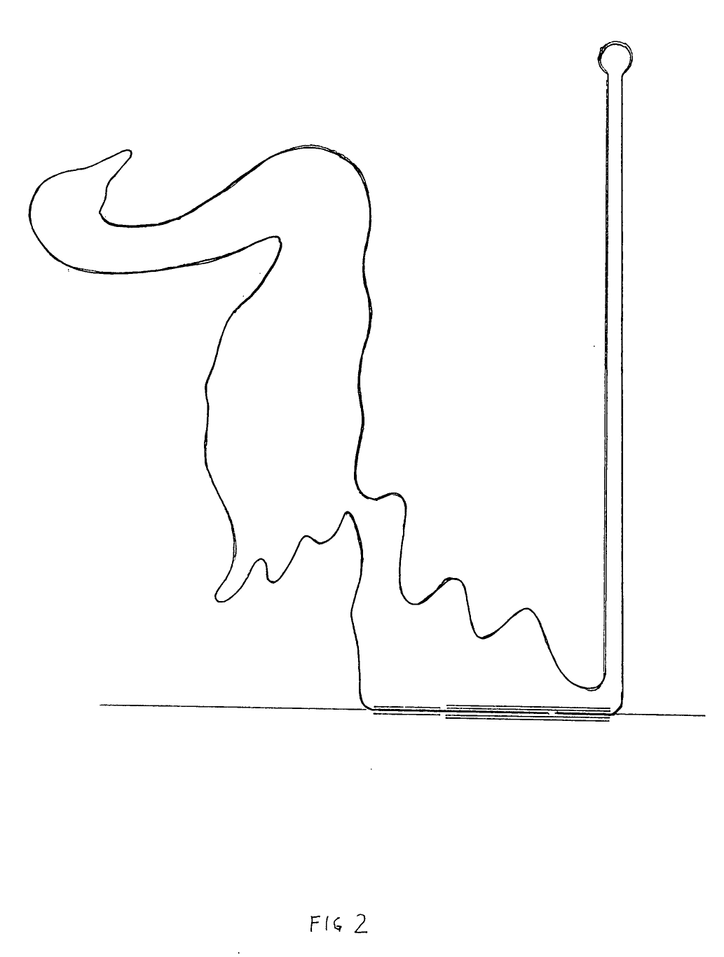

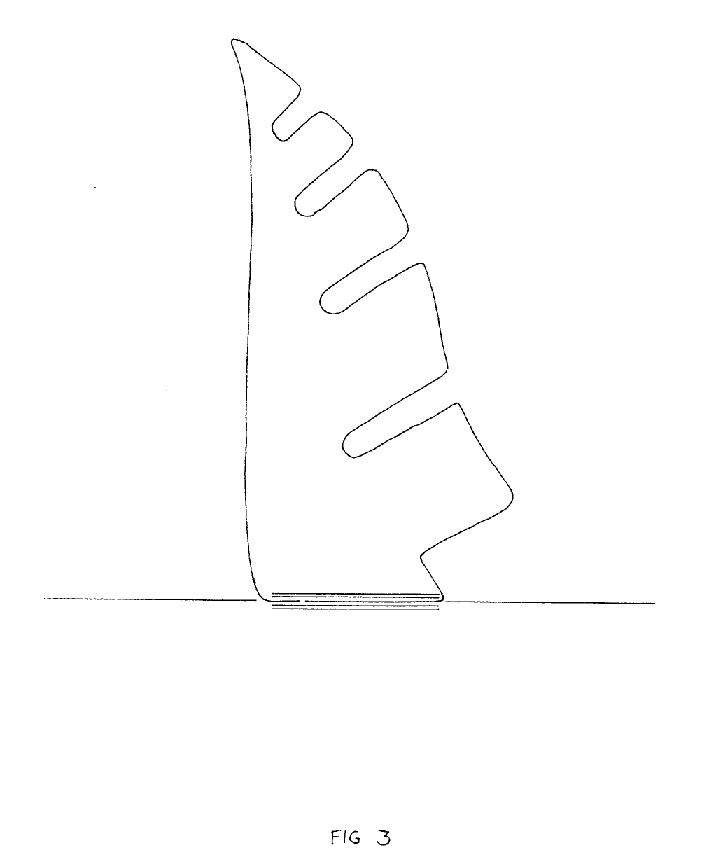

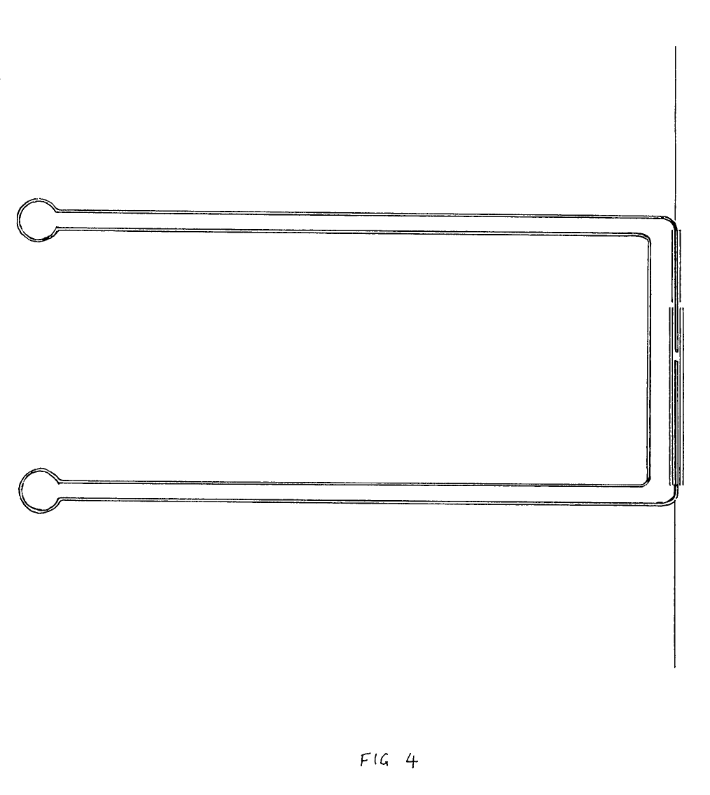

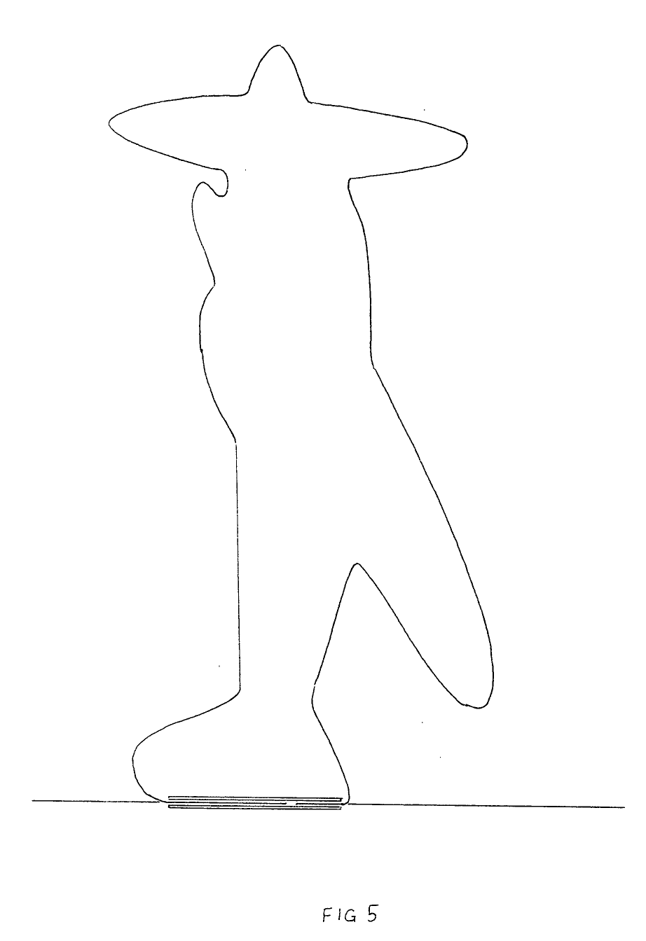

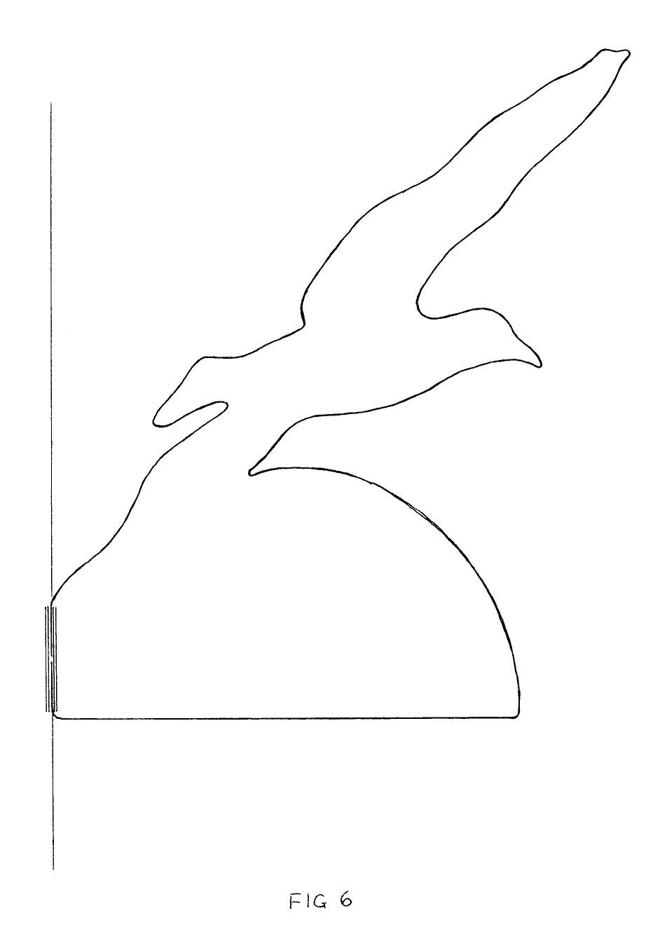

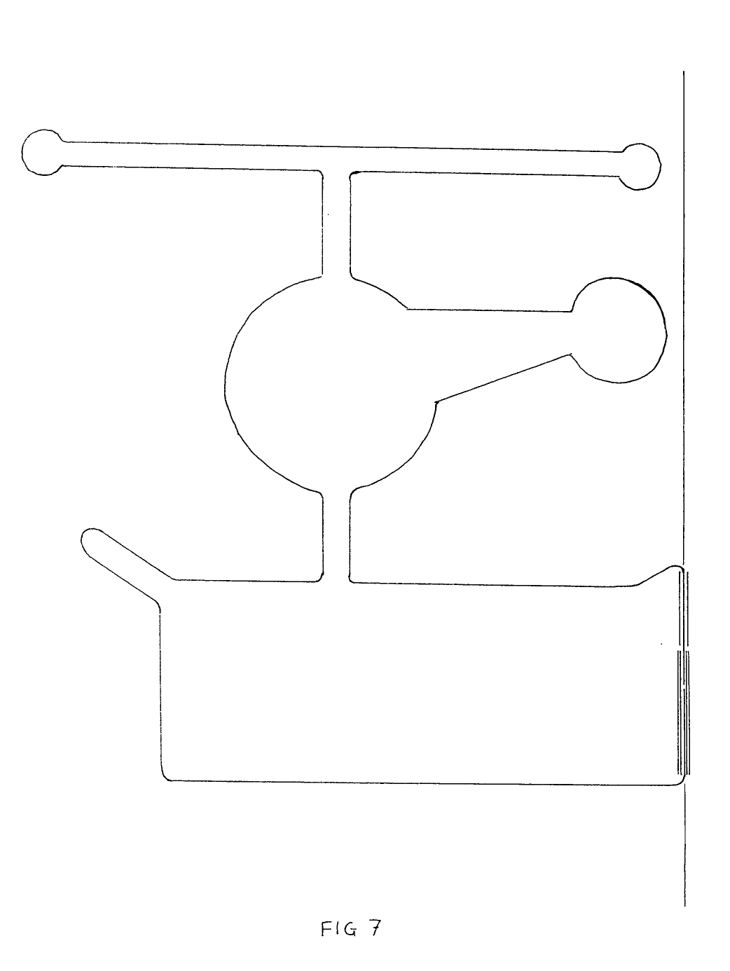

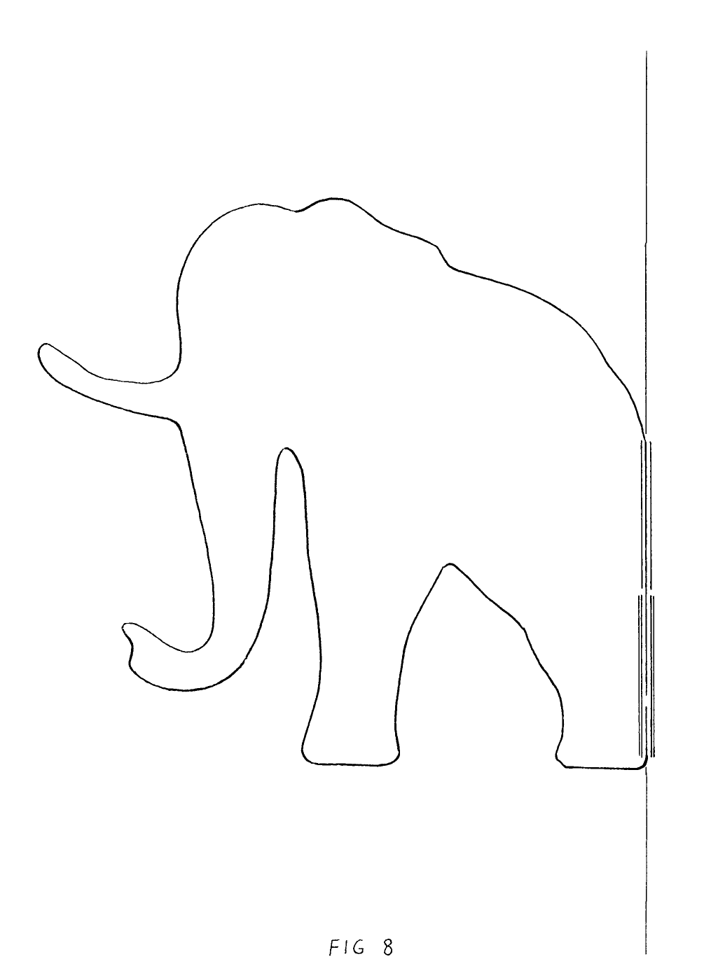

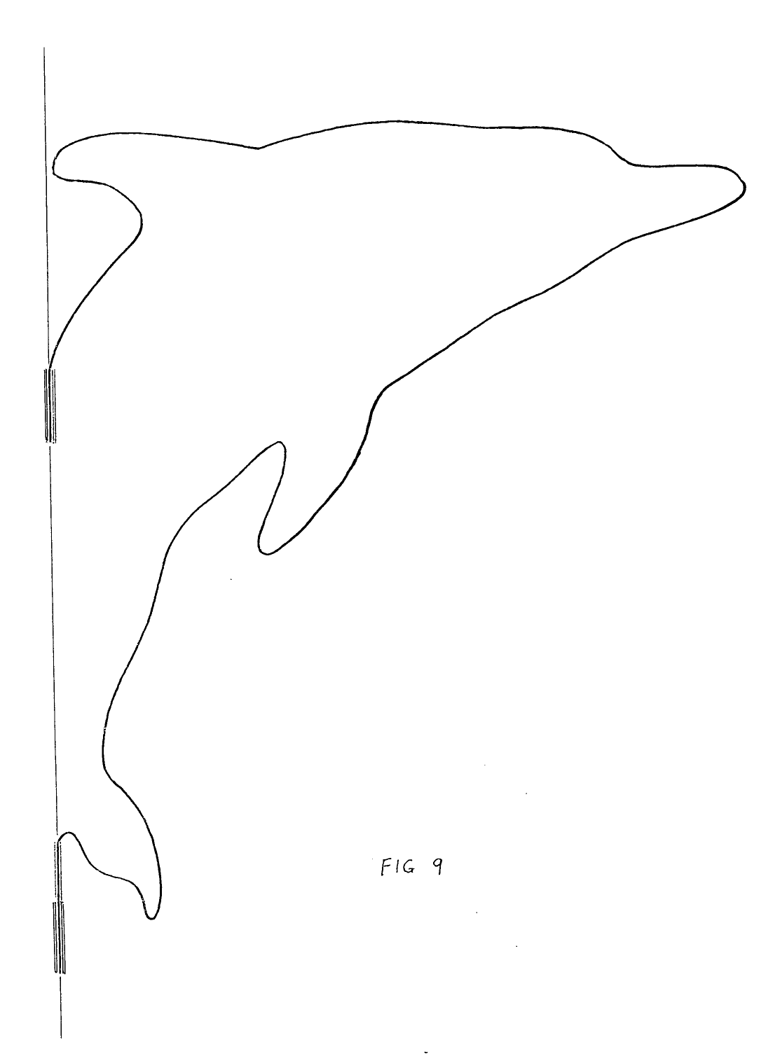

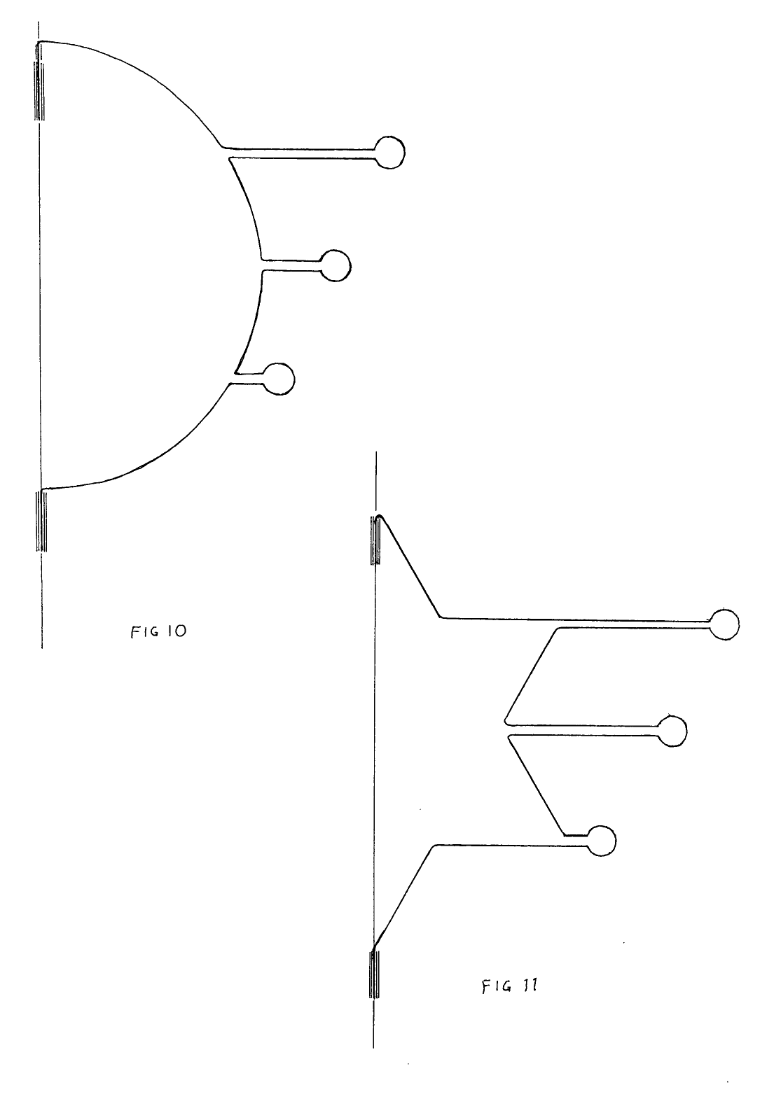

### BACKGROUND

A hanger can be formed from stainless steel rod and mounted on one or two door hinges by replacement of the original hinge pin/s by straight ends of the rod.

Advantages of using door hinges as mountings for hangers are the strength of the mountings, the ease of hanger installation and dismantlement, the usage of valuable space behind doors, the avoidance of damage to walls and doors from screw holes, and the wide applicability and usefulness of the hangers in commercial and domestic markets.

### FEATURES DISTINGUISHING THIS INVENTION FROM THE PRIOR ART

There are no examples in the prior art of decorative hangers which are suspended from door hinges by substitution of hinge pins.

The proposed hangers are composed of a single rod which is bent into the desired shape but which is otherwise unadulterated.

The hangers articulate only with hinge channels.

The mounting of the single continuous rod hanger by both of its ends on two separate hinges is novel.

The mounting of a single continuous rod hanger by both of its ends entering a single hinge channel, where one end of rod enters from above and one from below, and the hanger remaining in place on the hinge by spring forces, is not seen in the prior art.

### LIST OF RELATED PRIOR ART

| | | | |
|---|---|---|---|
| Bryand | 1909 | US | 914697 |
| Krodel | 1916 | US | 1208986 |
| Redin | 1939 | US | 2128596 |
| Kristensen | 1942 | US | 2270802 |
| Hunt | 1950 | US | 2509502 |
| Hanson | 1952 | US | 2595521 |
| Johnson | 1953 | US | 2633997 |
| Johnson | 1954 | US | 2684225 |
| Raber | 1960 | US | 2896791 |
| Martiello | 1960 | US | 2927761 |
| Szabo | 1962 | US | 3044630 |
| Milbourne | 1965 | US | 3175696 |
| Morrison | 1974 | US | 3825127 |
| Sciranka | 1995 | US | 5425462 |
| Rulis | 1996 | US | 5505317 |
| Lowe | 1998 | US | 4721212 |
| Loveland | 2000 | US | 6050427 |
| Oliver | 2001 | US | 6193084 |
| Lowe | 2001 | US | 6196398 |
| Kielland | 2003 | Ca | 2387430 |

### DESCRIPTION OF DRAWINGS

The drawings are self explanatory, and therefore features are not highlighted.

Each hanger is a simple structure formed from a rod by bends.

The rod is ether stainless steel or a suitable alternative material.

Each hanger mounts in either one or two hinges by substitution of hinge pin/s, and is therefore of a compatible calibre.

Hooks, rails, struts, brackets or racks are formed by simple bends incorporated in the hanger.

The two varieties of mountings are shown.

The first variety mounts by two straight end portions of rod entering the same hinge channel in a pincer-like fashion, and held in place by spring force (or by attaching a support strut which is not shown). One straight portion may be longer and inserted first for ease of installation in some of the examples.

The second variety mounts by two straight end portions of rod entering two separate hinge channels.

The use of a short length of tube, which slides onto the straight end portion of the rod and locks against the start of the bend, is seen in the drawings. This acts as a spacer to correct for hinge spacing discrepancies and as a bearing, which ensures freer rotation of articulating components.

What I claim is:

1. A hanger, constructed from stainless steel (or equivalent material) rod of a calibre closely conforming to that of a door hinge pin, with bends that form a structure of a desired shape which incorporates hooks and/or rails and/or struts and/or brackets and/or racks, and with both end portions of rod remaining straight and in line, each inserting into part or all of a hinge channel, thus each individually, or both jointly, replacing an original hinge pin, while providing two mounting attachments for the said hanger.

2. A hanger as defined in claim 1, with the addition of one or more lengths of stainless steel (or equivalent material) tube, which slides snugly over a said straight end portion and locks against the first bend to form a spacer device for correction of height discrepancies, or to limit the replacement hinge pin portions and/or to form a bearing to reduce friction at the end of the said hinge channel.

3. A hanger as defined in either claim 1 or claim 2, with the addition of separate brackets and/or hooks and/or support struts and/or racks and/or rails, and/or hangers, and/or decorations, which are attached by clipping, and/or sliding, and/or bolting, and/or riveting, and/or welding.

4. A hanger as defined in any one of claims 1 to 3, with a mounting mechanism where the said two ends are sprung together end to end to jointly occupy a single said fixed hinge channel.

5. A hanger as defined in any one of claims 1 to 3, with a mounting mechanism where each of the two said straight ends is inserted from above into its own fixed hinge channel.

6. A hanger substantially as herein described with reference to the accompanying drawings.
